(19) United States
(12) Patent Application Publication
(10) Pub. No.: US 2002/0152112 A1
(43) Pub. Date: Oct. 17, 2002

(54) System, method and user interface for reviewing projects to ensure criteria are met

(76) Inventors: Wayne T. Myers, Pittsfield, MA (US); Julie A. Sullivan, Greer, SC (US); Roger Schonewald, Scotia, NY (US); Keith Parker, Greer, SC (US)

Correspondence Address: BANNER & WITCOFF, 1001 G STREET N W, SUITE 1100, WASHINGTON, DC, 20001, US

(21) Appl. No.: 09/835,109

(22) Filed: Apr. 16, 2001

(51) Int. Cl. G06F 17/60

(52) U.S. Cl. 705/11

(57) ABSTRACT

A system, method and user interface for reviewing projects to ensure that specified criteria are met. The criteria may be externally mandated and/or internally required. The system and method utilize a user interface to control the creation of work packages that may be transmitted to suppliers for work to be performed domestically or globally. Uniform documentation and attachments can be created on-line using the interface of the system and method for reviewing projects so that specific benchmarks and reviews are met. Critical reviews may be a made mandatory step in the documentation process.

### FIELD OF THE INVENTION

The present invention relates to a system, method and user interface for reviewing projects so that specific benchmarks and reviews are performed during and after project development. More particularly, the present invention relates to a system, method and user interface for ensuring that both internal and external requirements and reviews are met during project development.

### BACKGROUND OF THE INVENTION

Typically, projects, such as engineering development projects, require the project be reviewed during the development process to ensure that criteria are met. Such criteria may be imposed from external sources, or be the result of internal project or company requirements.

The higher the number of people working on a project, the greater the likelihood is that a review of criteria for that project will be incomplete, inconsistent, or somehow insufficient. With regard to companies having large numbers of employees working on projects and multiple projects being developed simultaneously, there is a high likelihood that criteria will not be met completely, or that the criteria will be handled differently for each project or work group.

In the development of engineering projects, there are many criteria that must be met in order to meet external requirements. Similarly, there may be a need to review an engineering project with regard to internal criteria to ensure that company mandated steps and safeguards are taken.

Conventionally, such reviews or checks are not conducted in a standard fashion. Each project group may approach the criteria differently, with differing levels of completeness and degrees of information.

In particular, various engineers may coordinate work projects for transmission to outside suppliers, both domestically and internationally. The transmission of such projects may not be performed according to any standard approach. The transmissions may vary from person to person. As a result, suppliers may become confused by differing communications and therefore delay starting necessary work tasks, and thereby slow down completion of the project.

One criterion for such transmissions is a review of Export Control restrictions, which are United States Federal regulations for controlling, amongst other things, the transmission of technical data to a foreign national and the shipment of materials to countries under an embargo. Failure to heed Export Control restrictions can place the company in legal jeopardy. Other external restrictions also can be of concern, such as the handling of nuclear materials, which falls under the auspices of the Nuclear Regulatory Commission (NRC), or the disposal of hazardous wastes, which is administered by the Environmental Protection Agency (EPA).

With regard to internal criteria, one example is the review of project development with to protection of intellectual property. If a product or process under development is disclosed publicly before intellectual property rights are secured, the company may be unable to obtain any protection due to the establishment of a statutory bar. Likewise, such a disclosure prohibits the company from maintaining the product or process as a trade secret.

With regard to trademarks, it can also be critical to perform proper review and clearance of a potential trademark or service mark before marking goods or materials with the potential mark. Failure to do so can create serious legal ramifications. In larger companies, there is a strong likelihood that Export Control and intellectual property review are conducted differently throughout the company. Such reviews are difficult to control and coordinate, and the paperwork generated in such reviews is not maintained in a searchable database and is not archived. No electronic storage and retrieval process exists for such information.

### BRIEF SUMMARY OF THE INVENTION

The foregoing and other deficiencies of the conventional techniques are addressed by the system, method and user interface for reviewing projects to ensure criteria are met according to the present invention.

The present invention relates to a system, method and user interface for reviewing projects to ensure that specified criteria are met. The criteria may be externally mandated and/or internally required. The system, method and user interface according to the present invention can control the creation of work packages that may be transmitted to suppliers by members of the engineering community desiring to place tasks domestically or globally. Uniform documentation and attachments can be created on-line using the system and method of the present invention.

During the use of the system to document development, critical reviews may be a made mandatory step in the documentation process. An archive is created for each project in to which completed mandatory documentation may be maintained. By archiving such documentation, the subsequent users can save time in preparing similar documentation by accessing the archives and copying relevant documents.

### BRIEF DESCRIPTION OF THE DRAWINGS

The structure, operation and advantages of a presently preferred embodiment of this invention will become apparent upon consideration of the following description, taken in conjunction with the accompanying drawings in which:

FIG. 1 is a user interface log-on screen according to the present invention;

FIG. 2 is an initial system welcome screen and navigation bar according to the present invention;

FIG. 3 is an initial user interface selection screen, resulting from a user selecting the select SOW option in FIG. 2, according to the present invention;

FIGS. 4-6 are the initial user interface screen, shown in FIG. 3, for choosing an existing record through different SOW selection options, according to the present invention;

FIG. 7 is a user interface screen showing search results produced in response to a selection made in one of FIGS. 4-6, according to the present invention;

FIG. 8 is an initial user interface create SOW screen, produced in response to a user selecting create SOW in FIG. 3, according to the present invention;

FIG. 9 is a user interface screen for SOW creation, according to the present invention;

FIG. 10 is a user interface screen produced in response to a user selecting the SOW information option in the screen shown in FIG. 9, for entering SOW information, according to the present invention;

FIG. 11 is a user interface screen presented to a user upon selection of the contacts/appendices option in FIG. 9, according to the present invention;

FIG. 12 is a user interface screen presented to a user upon selection of the export control/IP checklist option in FIG. 9, according to the present invention;

FIGS. 13 and 14 are flow charts illustrating a an outsourcing process performed in conjunction with the method and system of the present invention; and

FIGS. 15 and 16 are flow charts of the method for reviewing projects to ensure that specified criteria are met, according to one preferred embodiment of the present invention.

### DETAILED DESCRIPTION OF THE INVENTION

The following discussion of the system, method and user interface of the present invention is directed to one preferred embodiment of the present invention, which is directed to export control and intellectual property protection. However, the illustrated embodiment is not intended to limit the present invention, but merely to be illustrative of one implementation of the concept. The present invention may be embodied on a computer system. A user can interact with the computer with a variety of input devices, such a keyboard and a pointing device. The pointing device may be a mouse, track ball, pen device, or similar device.

The computer can operate in a networked environment where it is connected to one or more remote computers or other devices, such as a server, a router, a network personal computer, a peer device or other common network node, a wireless telephone or wireless personal digital assistant. Networking environments are commonplace in offices, enterprise-wide computer networks and home computer systems.

The computer can also access a wide area network, such as the Internet. A local area network may also be used to connect to the wide area network. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

The user interface described in detail below is illustrated as running in a Microsoft® Windows® environment; however, the graphical user interface can run in other environments.

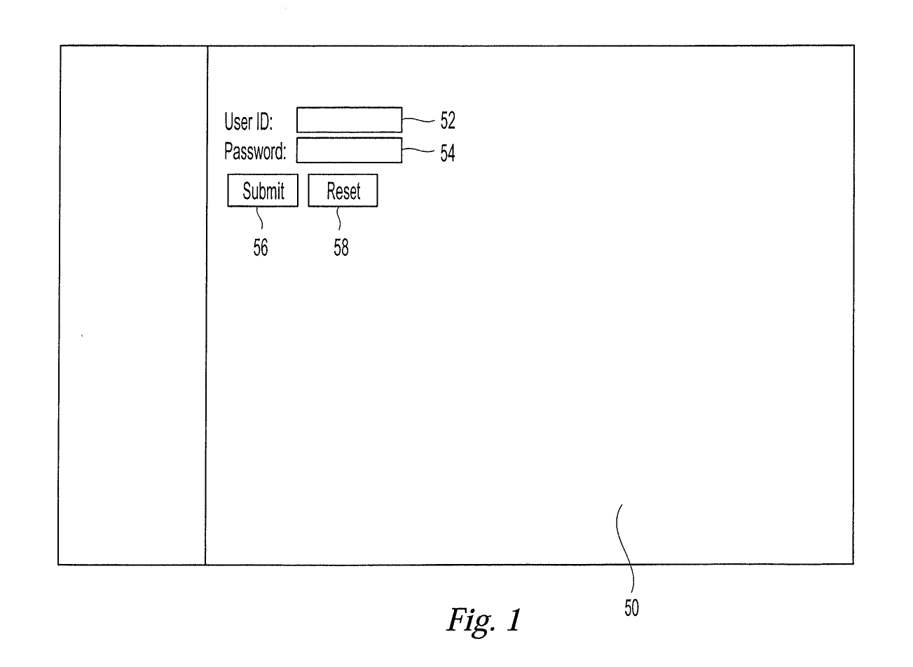

Referring to FIG. 1, a user interface log-on screen 50 is illustrated. Upon initialization of the system, a user is present with log-on screen 50 in order to limit access to the system to authorized users. Users are required to enter a user ID and password in user ID block 52 and password block 54, respectively, after which the user submits this information be selecting the submit button 56. If a user makes a mistake, the user can select the reset button 58 to reset the entries in blocks 52 and 54.

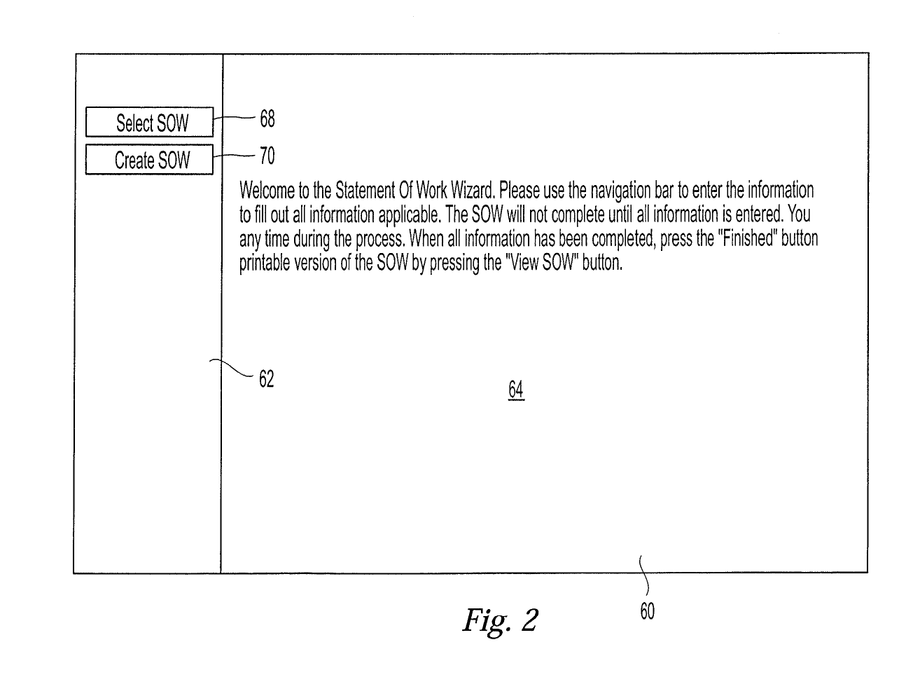

After entering an acceptable user ID and password, a user is presented with the initial system welcome screen 60 and navigation bar 62, shown in FIG. 2. General instructions are provided in the main window 64, and user selections are presented in the navigation bar 62. In the illustrated embodiment the user has two choices in the navigation bar 62, namely, select SOW option 68 and create SOW option 70. Each of these options will be described in detail below.

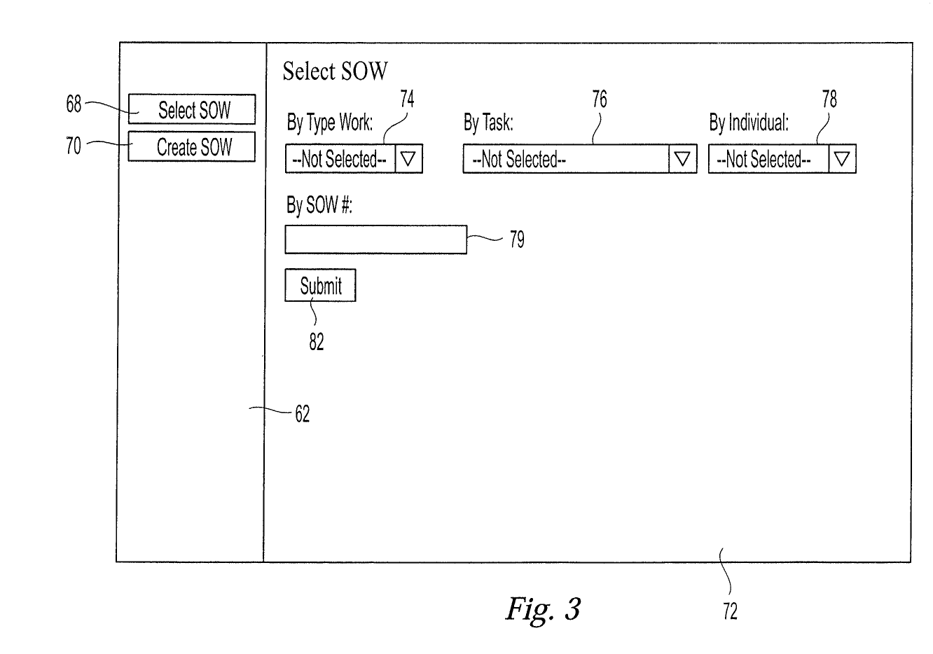

Selection of the select SOW option 68 in the navigation bar 62 of FIG. 2 brings up the initial user interface selection screen 72, shown in FIG. 3. Through the initial user interface selection screen 72, the user can select a previously enter project (termed a statement of work or SOW). The particular SOW may be chosen in multiple ways. In particular, the user may select the SOW by the type of work, by the task, or by another user. Referring to FIG. 3, the initial user interface selection screen 72 has three fields or windows; a type of work window 74, a task window 76, and an individual window 78. In addition, an SOW number window 79 is provided.

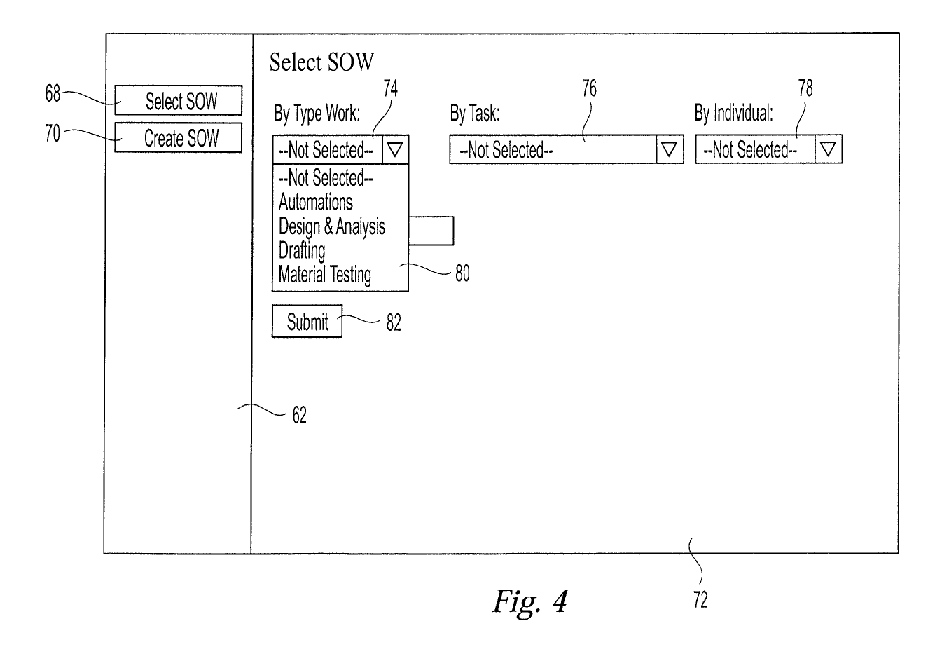

The results of the selection of each of the three fields, 74, 76, and 78, are shown in FIGS. 4-6. Referring to FIG. 4, selection of the type of work window 74 may open a drop down screen 80 containing a list of work types. In the example illustrated in FIG. 4, the drop down screen 80 contains four work types; automations, design & analysis, drafting, and materials testing. After the user selects one of these option, the selection is submitted by choosing the submit button 82.

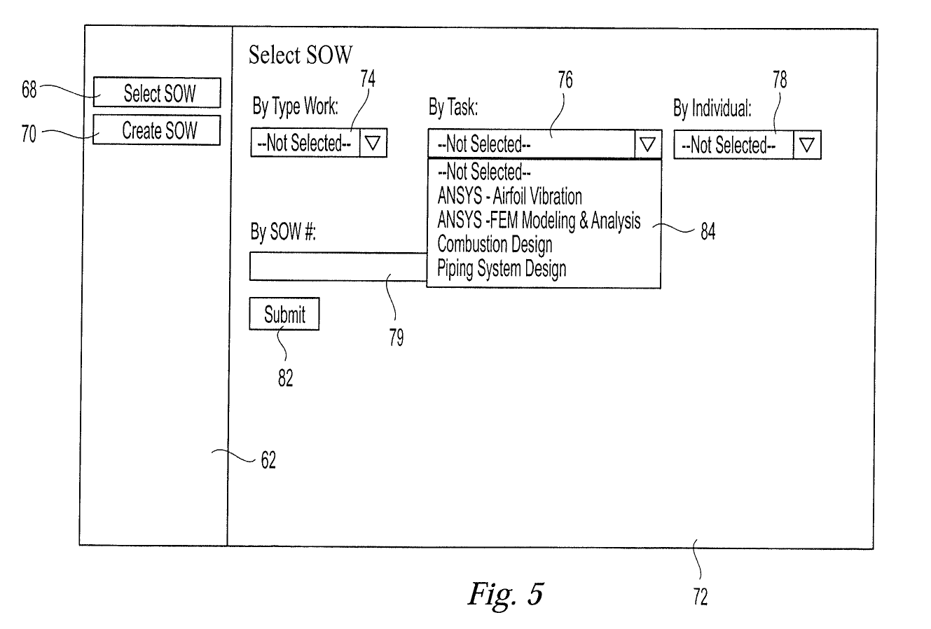

A drop down window 84, shown in FIG. 5, appears when a user selects a SOW using the task window 76. In the illustrated example shown in FIG. 5, the drop down window 84 contains four types of tasks, namely, ANSYS—Airfoil Vibration, ANSYS—FEM modeling & Analysis, Combustion design, and Piping System Design.

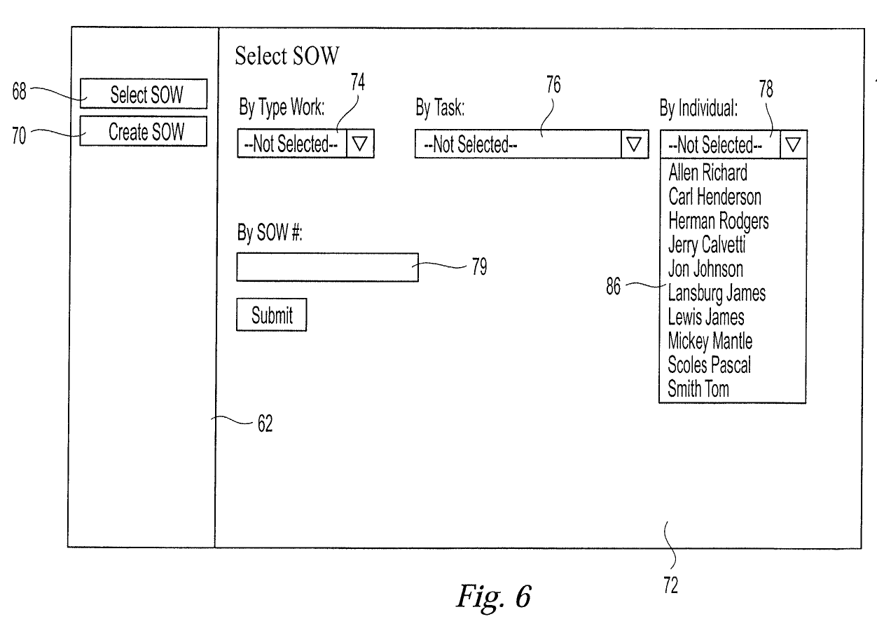

FIG. 6 illustrates a drop down window 86, which appears when a user selects the individual window 78. The drop down window 86 contains a list of people that have previously entered SOWs.

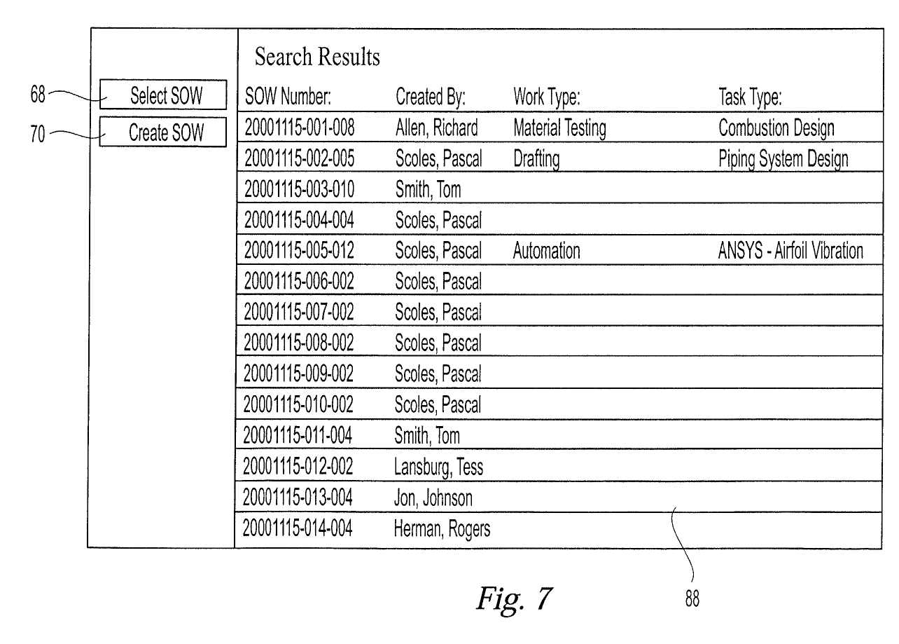

Selection using the type of work window 74, the task window 76, the individual window 78, or the Sow number window 79, produces a search results screen 88, shown in FIG. 7. The search results include all SOWs that match the selected field in the chosen drop down window. Each matching result may be displayed with information matching the fields in windows 74, 76, and 88. In addition, the each matching SOW may have an SOW number that is also displayed in the results screen 88 of FIG. 7.

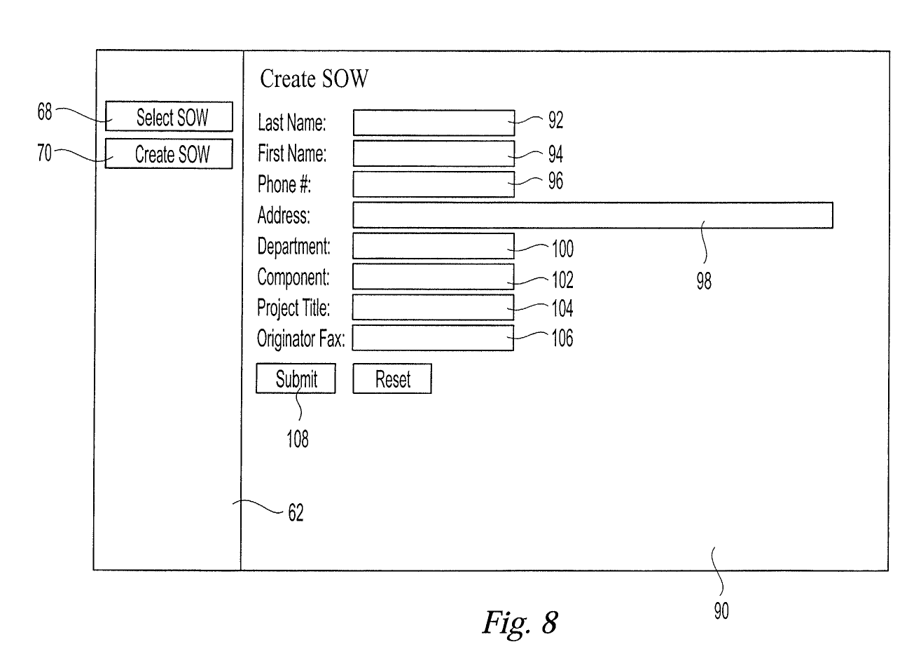

When a user wants to begin a new project, the project should be reviewed for any internal any external requirements. In the embodiment represented by FIGS. 1-12, these reviews are the export control review and the intellectual property protection review. In this instance, the user selects the create SOW option 70 in the navigation bar 62, shown in FIG. 2, and a create SOW screen 90 is presented, as shown in FIG. 8. The create SOW screen 90 has multiple field that user should complete before a SOW is created.

These fields include the user's last and first names 92 and 94, phone number 96, address 98, department 100, component 102, project title 104, and originator facsimile number 106. When the user has finished filling out the foregoing fields, the matter is submitted by selecting the submit button 108.

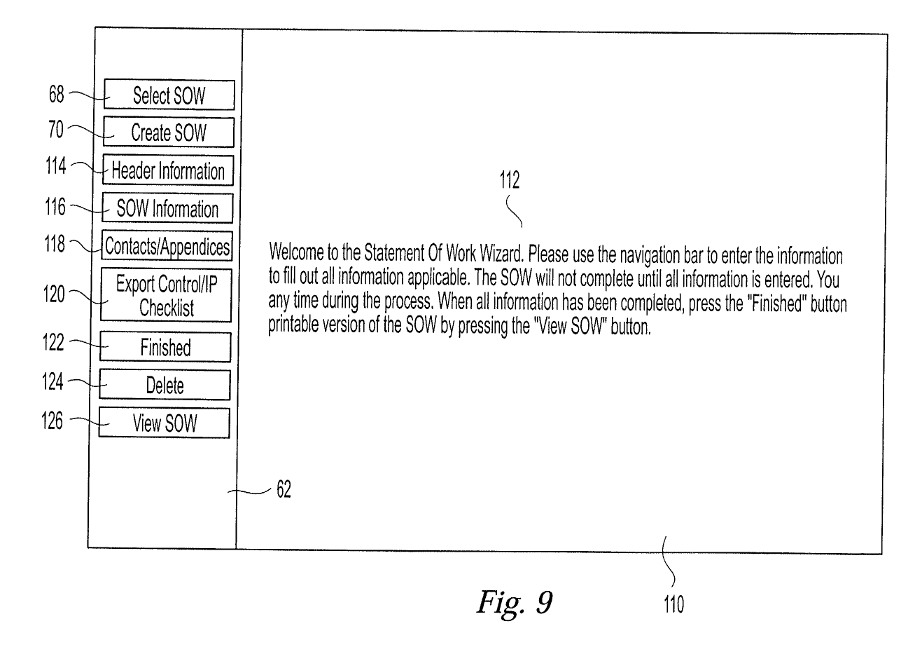

After the submit button 108 has been selected the user is presented with the user interface screen for SOW creation 110, shown in FIG. 9. The SOW creation screen includes the navigation bar 62 and a welcome screen 112. While all of the screens after the user interface log-on screen 50 include the navigation bar 62, screens 60, 72, 88, and 90 have only the two choices, select SOW option 68 and create SOW option 70 in the navigation bar 62.

On the other hand, screen 110 includes the navigation bar 62, but the navigation bar 62 has additional choices. These choices include Header information option 114, SOW Information option 116, Contacts/Appendices option 118, Export control/IP Checklist option 120, Finished option 122, Delete option 124, and View SOW option 126.

The welcome screen 112 provides the user with instructions concerning using the navigation bar during the SOW creation process. As the use enters information concerning a new project, the user can view all previously entered information by selecting the SOW Information option 116. When a user had completed entering all the information concerning a new project the SOW is completed by selecting the Finished option 122. A print out of the SOW is obtained by selecting the View SOW option 126.

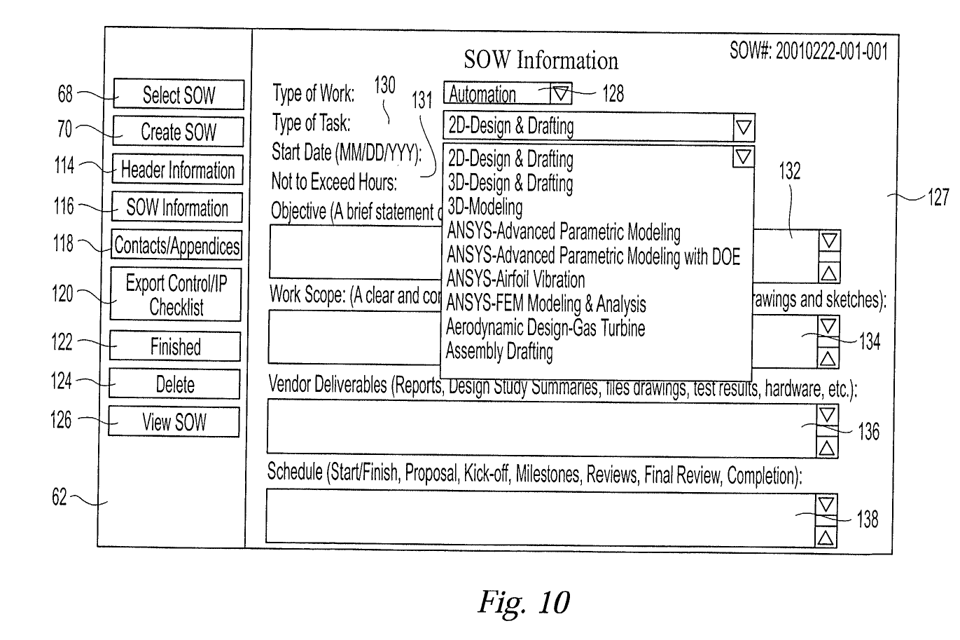

When the user selects the SOW Information option 116, a SOW Information user interface screen 127 is presented as shown in FIG. 10. The first item of information that should be entered is the type of work, which is entered in field 128. If the new project is of a similar nature to a previous project, the user can initiate field 128 as a drop down screen and select from the previous projects. On the other hand, if the new project is unlike previous projects, the user may manually enter the project type.

The next field is the type of task field 130, which can be completed in the same manner as field 128. The data entered into both fields 128 and 130 is accessible through the select SOW option 68 in the navigation bar 62. A not to exceed hours field 131 is provided so that the user may designate a maximum number of hours for the project.

The SOW information screen 110 has additional fields 132-138. Field 132 provides a location for the entry of the project objective, which should be a brief statement clarifying the purpose of the project. Field 134 is a work scope field that may contain an explanation of the work to be completed with reference to drawings and sketches. The vendor deliverables field 136 may contain reports, design study summaries, files, drawings, test results, hardware lists, etc. Schedule option 138 may contain the start and finished dates, proposal date, kick-off date, milestone date, review dates, final review date, and completion date.

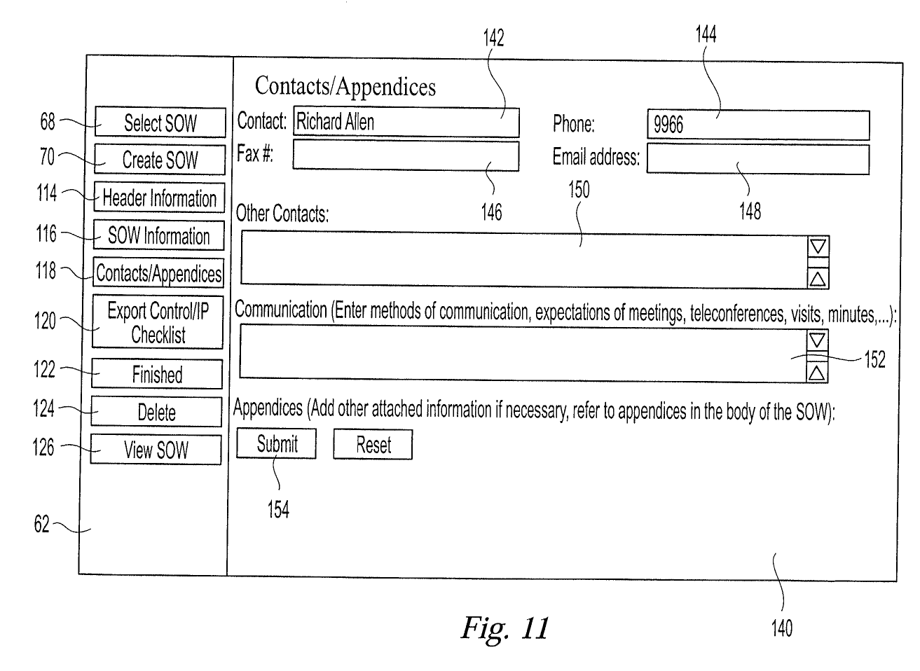

Selection of the Contacts/Appendices option 118 from the navigation bar 62 brings up the contacts/appendices screen 140, shown in FIG. 11. Screen 140 contains a contact field 142, into which the user may a responsible individual's name. Similarly, fields 144, 146, and 148 are provided for the user to enter phone number, facsimile number, and email address for the individual listed in field 142. Additional contacts may be added into the Other Contacts field 150, and corresponding communication channels in field 152. Upon completion, of the fields 142-152, the information is submitted to the system by selecting the submit button 154.

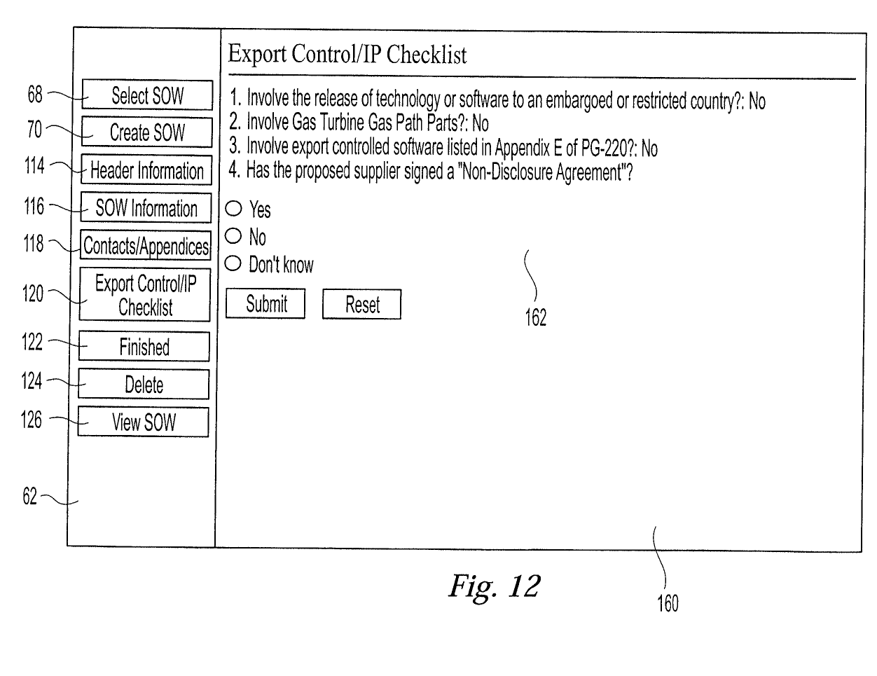

Selection of the Export control/IP checklist option 120 in the navigation bar 62 brings up the Export control/IP checklist screen 160 illustrated in FIG. 12. Screen 160 steps the user through a series of questions to ensure that the export control and intellectual property protection requirements are met. Some examples of these questions are shown in the main window 162. In this example, the user is asked if the project involves the release of technology or software to an embargoed or restricted country, does the project involve gas turbine gas path parts, does the project involve export controlled software, and has the proposed supplier signed a non-disclosure agreement. By requiring all users, who are responsible for a project to utilize the present system and method, uniform compliance with the export control and intellectual property requirements can be achieved.

With regard to intellectual property requirements, the questions presented in screen 160, may include, for example:

Has a patentability review been performed?

If the project involves potentially patentable subject matter, have all inventors been identified?

Has any public disclosure or offer for sale occurred? And if so when, and to whom, and under what circumstances?

Are any future disclosures to anyone outside of the project group expected, and if so, when, to whom, and under what circumstances?

Does the project involve trademarked goods or services?

Have all employees working on the project signed employee contracts requiring them to assign the rights to any inventions to the company?

Does the project relate to any previously patented inventions, and if so are they assigned to the same company?

All of the questions presented on screen 160 are intended to ensure that Federally imposed export control laws are complied with, and that in the course of the project, all potentially protectable intellectual property is protected.

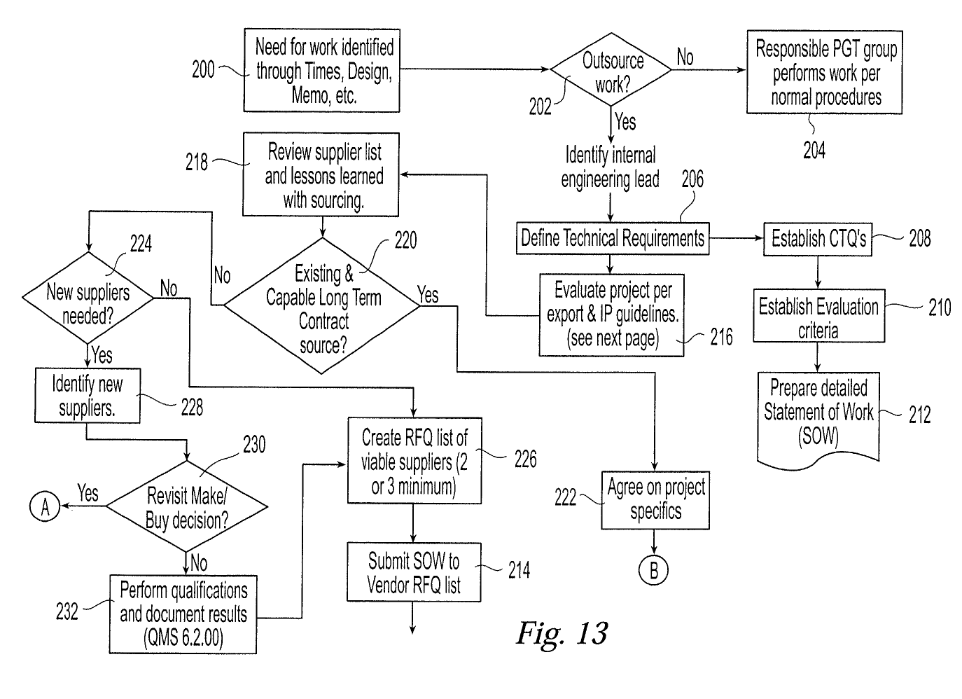

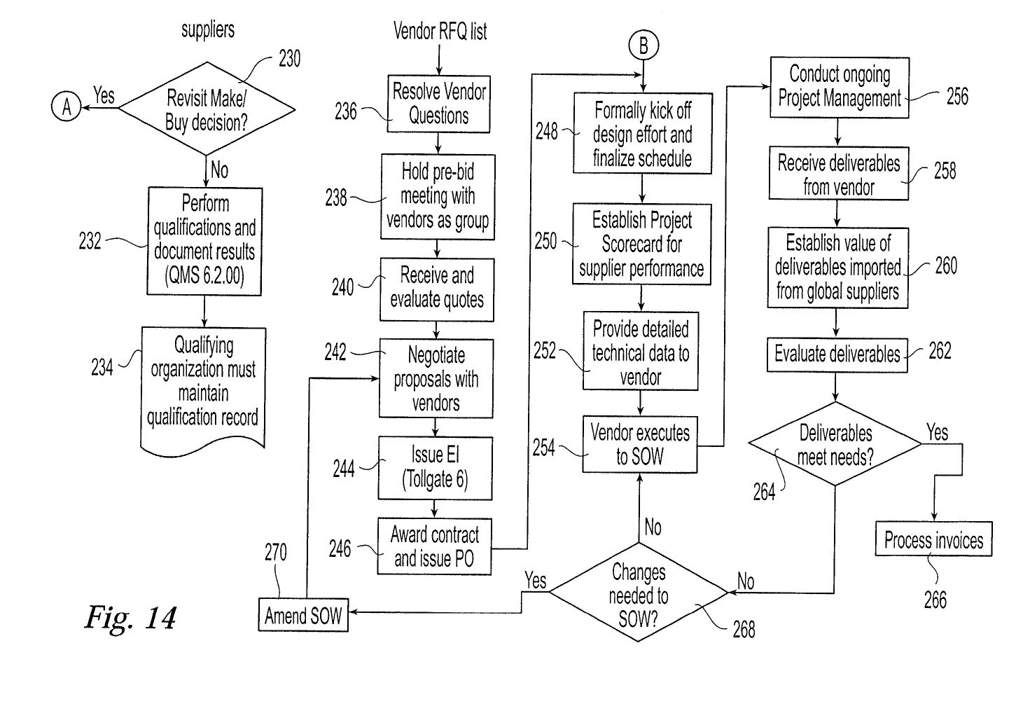

Quite often it is necessary to outsource one or more parts of an engineering project. When such outsourcing occurs, it is important that the project be kept under control to ensure that the externally mandated requirements and internal requirements are complied with. Referring to FIGS. 13 and 14, flow charts illustrating an outsourcing process performed in conjunction with the system and method of the present invention is illustrated. The flow charts assume that organizational resources, the complexity of the project, the business strategy, the technical scope/objective, the project schedule, and an approved supplier list, have all be determined and are available as inputs to the system.

In step 200 the need work to be performed is identified. In step 202 a determination is made whether to outsource the work. If the work is not to be outsourced, the responsible internal group performs the task in step 204. If a determination is made in step 202 that the work identified in step 200 is to be outsourced, the responsible internal engineering lead is identified, and the technical requirements are defined in step 206. After the technical requirements are identified in step 206, CTQ's (or issues critical to quality) are identified in step 208, and evaluation criteria are established in step 210.

After step 210, an SOW is prepared using the system, method and user interface of the present invention, in step 212. The SOW is a revision-controlled document containing a description of the work to be performed and the prescribed results and format. The SOW is archived and available for revisions or duplication. A copy of the SOW is delivered to the vendor RFQ (Request for Quotation) list in step 214.

After step 206, the project is reviewed with regard to the export control requirements and intellectual property requirements, in step 216, through the system and method of the present invention. The results of step 216 are sent to step 212. The results of step 216 are also sent to step 218 where the supplier list is reviewed. A part of step 218 is to review the task to ensure that proprietary agreements and related patent protection steps have been followed, using the system and method of the present invention.

Next, a determination is made in step 220 whether the supplier is an existing and capable long-term contract source. If the answer is yes then the project specifics are agreed upon in step 222. If the answer is no, then A determination is made whether new suppliers are needed in step 224. If the answer is no than the RFQ list of viable suppliers is created in step 226, and the step 214 is then followed.

If the answer in step 224 is yes, then new suppliers are identified in step 228, and in step 230 a buy decision is made. If a buy is not to be made then qualifications and document results are performed in step 232, and the process proceeds to step 226. If the answer is yes then the purchase is made.

After step 232, as shown in FIG. 14, the qualifying organization is required to maintain qualification records in step 234. Furthermore, after step 214, vendor questions are resolved in step 236, and a pre-bid meeting is held in step 238. After step 238, quotes are received and evaluated in step 240. Proposals are negotiated with the vendors in step 242, and an EI (Engineering Instruction) is issued in step 244. In step 246, a contract is awarded and a PO (Purchase Order) is issued.

After steps 220 and 246, the design effort is started and a schedule is finalized in step 248. A system for evaluating the suppliers' performance is determined in step 250. Next detailed technical data is provided to the vendor in step 252, and the vendor executes the project according to the SOW, in step 254. Next, ongoing project management is conducted in step 256, and deliverables are received from the vendor in step 258. The value of the deliverables, imported from global suppliers, is established in step 260, after which the deliverables are evaluated in step 262. A determination is made in step 264 whether the deliverables are satisfactory. If yes a process invoice is issued in step 266. If the answer in step 264 is no the process continues to step 268 where a determination is made whether the SOW needs to be changed. If the answer in step 268 is no then step 254 through 264 are repeated. If the answer in step 268 is yes the SOW is amended in step 270, and the process repeats from step 242 through step 264.

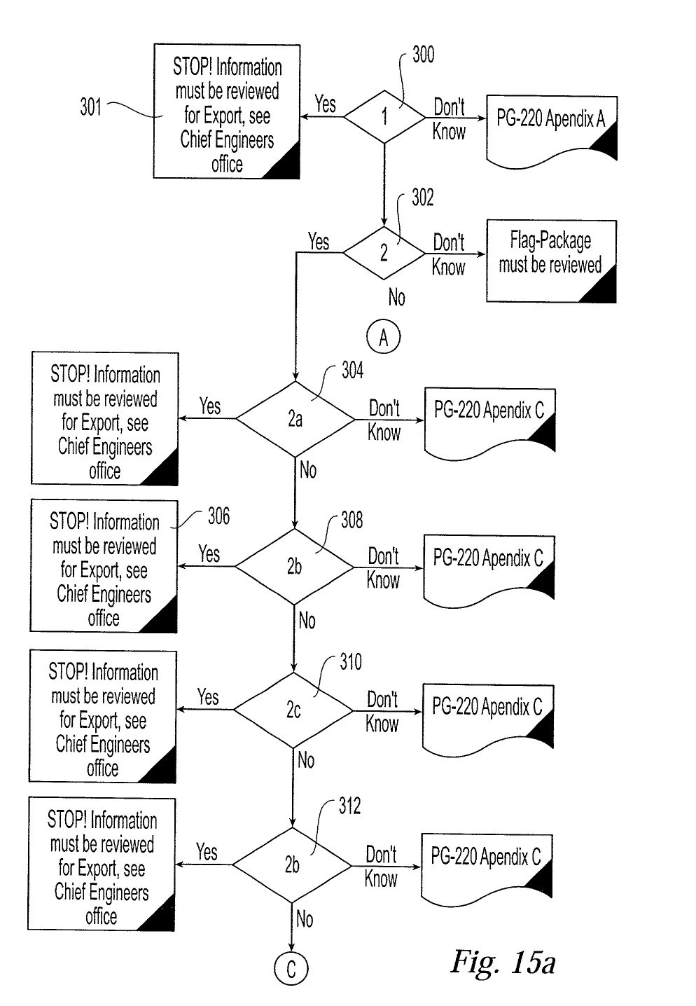

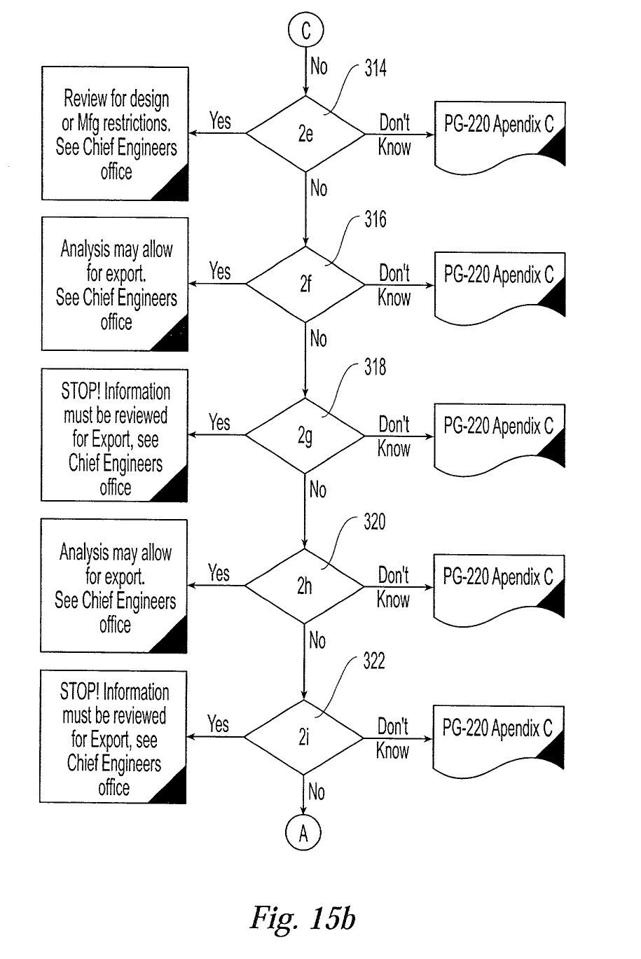

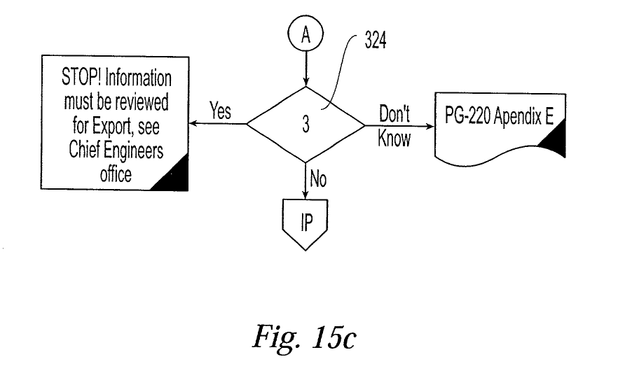

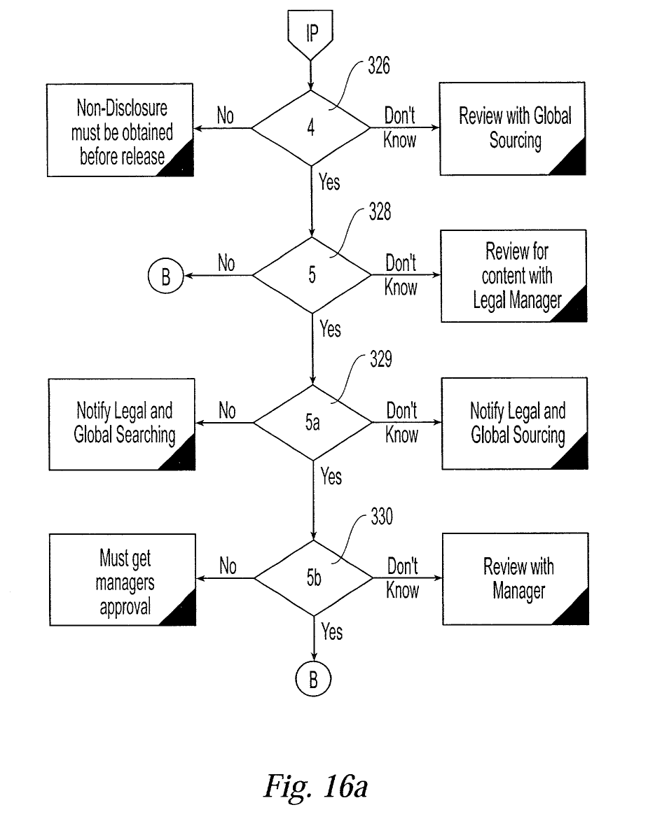

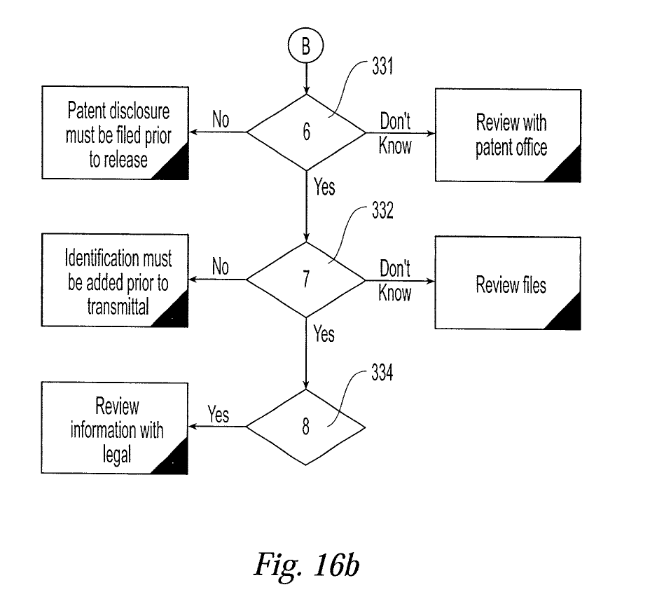

FIGS. 15 and 16 are flow chart of the method for reviewing projects to ensure that specified criteria are met, according to one preferred embodiment of the present invention. These criteria are the same questions set forth in the Export control/IP checklist 160. In step 300 a determination is made whether the project involves the release of technology or software to an embargoed or restricted country. If the answer is yes the system informs the user that the information must be reviewed for export in step 301. If the answer is no the process continues to step 302.

In step 302 a determination is made whether the project involves gas turbine gas path parts. If the user's answer is do not know, the project needs to be reviewed. If, the answer is yes then step 304 is executed where a determination is made whether the project contains material or processing technology. If the answer is yes the system informs the user that the information must be reviewed for export in step 306. The process then proceeds through the following decision steps:

Does the project involve cooled airfoils or shrouds in an average gas path temperature? (Step 308)

Does the project involve uncooled airfoils or shrouds in an average gas path temperature? (Step 310)

Does the project involve turbine bucket tip active clearance control? (Step 312)

Does the project involve cooling holes with a diameter less than 0.030 inches and L/D greater than 4, and an incident angle less than 25 degrees? (Step 314)

Does the project involve airfoils or shrouds made from directionally solidified or single crystal alloy with 400 hr. S-R life at 1000 degrees C. and 200 MPS? (Step 316)

Does the project involve components from 600 degrees F., organic composites, metal matrix composites (MMC) ceramic metal composites (CMC) or intermetallic or intermetallic-reinforced composites? (Step 318)

Does the project involve coating processes such as PVD, CVD and low-pressure plasma spray? (Step 320)

Does the project involve hot gas path design practice? (Step 322).

If the answers in any of steps 308 through 322 is yes, then the user that the information must be reviewed for export

In step 324 a determination is made whether the project involves export controlled software. In step 326 a determination is made whether the proposed supplier signed a non-disclosure agreement. In step 328 a determination is made whether there is potential for the supplier to develop patentable ideas while performing the proposed tasks. If the component, for which external engineering services are planned, has any internal patentable ideas, a determination is made whether the appropriate patent disclosure forms have been filed with the appropriate patent offices in step 330. Step 329 requires a determination whether outside suppliers have existing patent protection relating to the project. Step 330 involves determining that the project will not infringe third party patent rights. Next, step 331 involves determining if patent applications have been filed for the project. In step 332 a determination is made whether required intellectual property identification has been added to all necessary items. In step 334 a determination is made whether the system user has been requested to sign a non-disclosure agreement.

While the foregoing embodiment is directed to the specific implementation of an export control review scheme and an intellectual property review, the present invention is not intended to be limited to just these developments. The system, method and user interface of the present invention is equally applicable to reviews, such as nuclear regulatory commission regulations, atomic energy restrictions, EHS (Environmental Health Safety) review, Hazardous materials review, North American Free Trade Agreement (NAFTA) requirements, European Union (EU) requirements, military specification compliance, building/zoning requirements, any special industry requirements such as ASME or ANSI, and any special government requirements such as equal opportunity employment or hiring.

Having described embodiments of the system and method and user interface for reviewing projects so that specific benchmarks and reviews are performed during and after project development according to the present invention, it is believed that other modifications, variations and changes will be suggested to those skilled in the art in view of the description set forth above. It is therefore to be understood that all such variations, modifications and changes are believed to fall within the scope of the invention as defined in the appended claims.

What is claimed is:

1. A computer readable medium having computer-executable instructions for performing project review steps comprising:
creating a new project or selecting an existing project;
inputting project-file creator information;
inputting project information; and
answering required project review questions.

2. A computer readable medium having computer-executable instructions for performing project review steps as recited in claim 1, wherein said questions pertain to externally imposed requirements.

3. A computer readable medium having computer-executable instructions for performing project review steps as recited in claim 2, wherein said externally imposed requirements are promulgated in government regulations and laws.

4. A computer readable medium having computer-executable instructions for performing project review steps as recited in claim 3, wherein said regulations and Laws relate to export control.

5. A computer readable medium having computer-executable instructions for performing project review steps as recited in claim 1, wherein said questions pertain to internally imposed requirements.

6. A computer readable medium having computer-executable instructions for performing project review steps as recited in claim 5, wherein said internally imposed requirements relate to protection of intellectual property.

7. A computer readable medium having computer-executable instructions for performing project review steps as recited in claim 1, wherein said step of creating a new project comprises inputting project data through a project creation screen.

8. A computer readable medium having computer-executable instructions for performing project review steps as recited in claim 7, wherein said project information, entered in said projection information inputting step, comprises objective data, work scope data, vendor deliverable data, schedule data, and data defining the project.

9. A computer readable medium having computer-executable instructions for performing project review steps as recited in claim 7, wherein comprising the further step of inputting information relating to a person responsible for said project.

10. A computer readable medium having computer-executable instructions for performing project review steps as recited in claim 1, comprising the further step of restricting access to said interface.

11. A computer readable medium having computer-executable instructions for performing project review steps as recited in claim 1, wherein said step of selecting an existing project comprises searching for said existing project based upon project information concerning said existing project that had been previously inputted upon creation of said existing project as a new project in said new project creation step.

12. A computer readable medium having computer-executable instructions for performing project review steps as recited in claim 11, wherein said searching step comprises inputting information into specific fields set forth on the display to obtain an existing project having information matching said information inputted into said fields.

13. A computer readable medium having computer-executable instructions for performing project review steps as recited in claim 12, wherein said fields comprise a type of work field, a task field, an individual field and a project number field.

14. A computer readable medium having computer-executable instructions for performing project review steps as recited in claim 1, wherein said fields include drop down screens that provide an index to information entered into said fields for existing projects.

15. A computer readable medium having computer-executable modules/components comprising:
a first interface for creating a new project or selecting an existing project;
a second interface for inputting project-file creator information;
a third interface for inputting project information; and
a fourth interface for answering required project review questions.

16. A computer readable medium having computer-executable modules/components as recited in claim 15, wherein said questions pertain to externally imposed requirements.

17. A computer readable medium having computer-executable modules/components as recited in claim 16, wherein said externally imposed requirements are promulgated in government regulations and laws.

18. A computer readable medium having computer-executable modules/components as recited in claim 17, wherein said regulations and laws relate to export control.

19. A computer readable medium having computer-executable modules/components as recited in claim 15, wherein said questions pertain to internally imposed requirements.

20. A computer readable medium having computer-executable modules/components as recited in claim 19, wherein said internally imposed requirements relate to protection of intellectual property.

21. A computer readable medium having computer-executable modules/components as recited in claim 15, wherein said step of creating a new project comprises inputting project data through a project creation screen.

22. A computer readable medium having computer-executable modules/components as recited in claim 21, wherein said project information, entered in said projection information inputting step, comprises objective data, work scope data, vendor deliverable data, schedule data, and data defining the project.

23. A computer readable medium having computer-executable modules/components as recited in claim 21, wherein comprising the further step of inputting information relating to a person responsible for said project.

24. A computer readable medium having computer-executable modules/components as recited in claim 15, comprising the further step of restricting access to said interface.

25. A computer readable medium having computer-executable modules/components as recited in claim 15, wherein said step of selecting an existing project comprises searching for said existing project based upon project information concerning said existing project that had been previously inputted upon creation of said existing project as a new project in said new project creation step.

26. A computer readable medium having computer-executable modules/components as recited in claim 25, wherein said searching step comprises inputting information into specific fields set forth on the display to obtain an existing project having information matching said information inputted into said fields.

27. A computer readable medium having computer-executable modules/components as recited in claim 26, wherein said fields comprise a type of work field, a task field, an individual field and a project number field.

28. A computer readable medium having computer-executable modules/components as recited in claim 15 wherein said fields include drop down screens that provide an index to information entered into said fields for existing projects.

29. In a computer system having a graphical user interface including a display and a user interface device, a method of providing and selecting from a project review menu on the display, comprising the steps of:
creating a new project or selecting an existing project;
inputting project-file creator information;
inputting project information; and
answering required project review questions.

30. In a computer system having a graphical user interface including a display and a user interface device, a method of providing and selecting from a project review menu on the display, as recited in claim 29, wherein said questions pertain to externally imposed requirements.

31. In a computer system having a graphical user interface including a display and a user interface device, a method of providing and selecting from a project review menu on the display, as recited in claim 30, wherein said externally imposed requirements are promulgated in government regulations and laws.

32. In a computer system having a graphical user interface including a display and a user interface device, a method of providing and selecting from a project review menu on the display, as recited in claim 31, wherein said regulations and laws relate to export control.

33. In a computer system having a graphical user interface including a display and a user interface device, a method of providing and selecting from a project review menu on the display, as recited in claim 29, wherein said questions pertain to internally imposed requirements.

34. In a computer system having a graphical user interface including a display and a user interface device, a method of providing and selecting from a project review menu on the display, as recited in claim 32, wherein said internally imposed requirements relate to protection of intellectual property.

35. In a computer system having a graphical user interface including a display and a user interface device, a method of providing and selecting from a project review menu on the display, as recited in claim 29, wherein said step of creating a new project comprises inputting project data through a project creation screen.

36. In a computer system having a graphical user interface including a display and a user interface device, a method of providing and selecting from a project review menu on the display, as recited in claim 34, wherein said project information, entered in said projection information inputting step, comprises objective data, work scope data, vendor deliverable data, schedule data, and data defining the project.

37. In a computer system having a graphical user interface including a display and a user interface device, a method of providing and selecting from a project review menu on the display, as recited in claim 34, wherein comprising the further step of inputting information relating to a person responsible for said project.

38. In a computer system having a graphical user interface including a display and a user interface device, a method of providing and selecting from a project review menu on the display, as recited in claim 29, comprising the further step of restricting access to said interface.

39. In a computer system having a graphical user interface including a display and a user interface device, a method of providing and selecting from a project review menu on the display, as recited in claim 29, wherein said step of selecting an existing project comprises searching for said existing project based upon project information concerning said existing project that had been previously inputted upon creation of said existing project as a new project in said new project creation step.

40. In a computer system having a graphical user interface including a display and a user interface device, a method of providing and selecting from a project review menu on the display, as recited in claim 39, wherein said searching step comprises inputting information into specific fields set forth on the display to obtain an existing project having information matching said information inputted into said fields.

41. In a computer system having a graphical user interface including a display and a user interface device, a method of providing and selecting from a project review menu on the display, as recited in claim 40, wherein said fields comprise a type of work field, a task field, an individual field and a project number field.

42. In a computer system having a graphical user interface including a display and a user interface device, a method of providing and selecting from a project review menu on the display, as recited in claim 29, wherein said fields include drop down screens that provide an index to information entered into said fields for existing projects.
